(19) United States
(12) Patent Application Publication
(10) Pub. No.: US 2011/0066681 A1
(43) Pub. Date: Mar. 17, 2011

(54) CLIENT DEVICE, CONTROL METHOD THEREOF, PROGRAM, SERVER DEVICE, CONTROL METHOD THEREOF, COMMUNICATION SYSTEM, AND CONTROL METHOD THEREOF

(76) Inventors: Naoki Shiota, Tokyo (JP); Hiroyuki Tomimori, Tokyo (JP); Masaya Fujiwaka, Tokyo (JP)

(21) Appl. No.: 12/991,389

(22) PCT Filed: May 14, 2009
(86) PCT No.: PCT/JP2009/058982

§ 371 Date: Nov. 5, 2010

(30) Foreign Application Priority Data
May 14, 2008 (JP) 2008-127578

(51) Int. Cl. G06F 15/16

(52) U.S. Cl. 709/203

(57) ABSTRACT

It is possible to automatically execute an offline Web application without requiring installation of software. A mobile terminal includes: a client program, a server program execution environment and a local proxy server. An application server has a server program. The local proxy server of the mobile terminal acquires a server program from the application server in accordance with an HTTP request from the client program and installs the program in the server program execution environment. When the installation is complete, synchronization with the server program of the application server side is executed. The local proxy server divides the HTTP request from the client program to a server program on the mobile terminal and a server program on the application server.

### TECHNICAL FIELD

The present invention relates to a client device, a control method thereof, a program, a server device, a control method thereof, a communication system, and a control method thereof, and in particular, relates to a network application system.

### BACKGROUND ART

It is generalized to send and receive various data via the internet by virtue of a network with broad bandwidth, and a computer with high performance and low costs. In particular, the art such as SaaS (Software as a Service) and ASP (Application Service Provider), which can use a network application on a web browser, attracts much attention from a viewpoint that installation of software is unnecessary and a plurality of terminals can use an identical application as far as each terminal has a browser.

Meanwhile, a mobile terminal, whose representative example is a cellular phone, progresses in its performance, and has almost the same function as PC has. With regard to a web browser in particular, a browser, which has functions equivalent to ones of a browser working on PC, works on the mobile terminal, and consequently, it is possible that the mobile terminal carries out the same web application as PC carries out.

However, it is necessary that the mobile terminal uses wireless bearer for communication. The mobile terminal is quite different from PC in a point that a radio wave environment of the mobile terminal is dynamic. While PC uses radio in some cases, PC uses the radio at a fixed position and at a seat in almost all cases. A radio wave environment around PC is static or quasi-static. In the dynamic radio wave environment in contrast to the static or quasi-static environment, communication, in some cases, may become unstable due to high-speed movement and noise, and may become impossible temporarily since the mobile terminal moves into an area where radio wave can not reach like an underground area and an area outside a cover area of an antenna.

It is not neglected that the mobile terminal is caused also a problem of electric power. Since a web application communicates quite frequently in general, the web application requires a large amount of electric power for communication. For this reason, it is not suitable that the mobile terminal, which has limitation in a battery capacity, uses the web application for a long time.

That is, there is a problem that the mobile terminal can not obtain the same convenience as PC has due to the instability of communication and the limitation of electric power, even if the mobile terminal tries to use the Web application like PC.

To cope with the problem, an art that a server program, which works on an application server, is installed into a mobile terminal as it is, and only process, which does not require to rewrite data, is carried out by the server program of the mobile terminal is proposed (patent document 1).

### THE PRECEDING TECHNICAL DOCUMENT

[Patent document]

[Patent document 1] Japanese Patent Application Laid-Open. No. 2001-051839

### BRIEF SUMMARY OF THE INVENTION

### Problem to be Solved by the Invention

However, the art disclosed in the patent document 1 aims at a simple Web application for business use such as referencing to data stored in a server and carrying out updating. The art disclosed in the patent document 1 is not applied to a complicated web application which refers to and processes a plurality of user data and DBs (Database) like SNS (Social Networking Service).

Moreover, the art disclosed in the patent document 1 assumes implicitly that a mobile terminal can use a telephone line always. Moreover, the art disclosed in the patent document 1 does not assume use of the mobile terminal in an area where radio does not reach, and use of the mobile terminal which moves at a high speed, both of which result in impossible communication.

In consideration of the above-mentioned problem, an object of the present invention is to provide an art by which it is possible to carry out a web application, which carries out a complicated data process, even in an environment in which any communication means cannot be used at all.

### Means for Solving the Problem

In order to achieve the above-mentioned object, the present invention has the following feature.

A client device according to the present invention, which is connected via a network to a server computer carrying out a server program, includes a client program which communicates with the server program, a server program distribution means which acquires the server program from the server computer and distributes the acquired server program to the client device, and a local proxy means which, when the client program issues a request to the server program, judges whether the request can be processed by the distributed server program, and sends the request to the server program which is executed on the server computer, in the case that the local proxy means judges that the request can not be processed.

A control method of a client device according to the present invention for controlling the client device which is connected via a network to a server computer carrying out a server program and which includes a client program communicating with the server program, includes a server program distribution step of acquiring the server program from the server computer and distributing the acquired server program to the client device, and a step in which, when the client program issues a request to the server program, it is judged whether the request can be processed by the distributed server program, and the request is sent to the server program which is executed on the server computer, in the case that it is judged that the request can not be processed.

A program of a client device according to the present invention makes the client device, which is connected via a network to a server computer carrying out a server program and which includes a client program communicating with the server program, function as a server program distribution means which acquires the server program from the server computer and distributes the acquired server program to the client device, and as a local proxy means which, when the client program issues a request to the server program, judges whether the request can be processed by the distributed server program, and sends the request to the server program which is executed on the server computer, in the case that the local proxy means judges that the request can not be processed.

A server device according to the present invention, which is connected via a network to a client device carrying out a client program, includes a server program which communicates with the client program, a server program providing means which sends a subset of the server program to the client device, a server program synchronization means which sends a change added to the server program to the client device. The server program carries out a process, in the case that the client program issues a request to the server program and the request is sent to the server program.

A control method of a server device according to the present invention for controlling the server device which is connected via a network to a client device carrying out a client program and which includes a server program communicating with the client program, includes a server program providing step for sending a subset of the server program to the client device, a server program synchronization step for sending a change added to the server program to the client device, and a step in which the server program carries out a process, in the case that the client program issues a request to the server program and the request is sent to the server program.

A first communication system according to the present invention includes a client device and a server device, which are connected each other via a network. The client device includes a client program for communicating with a server program which the server device carries out, a server program distribution means which acquires the server program from the server device and distributes the acquired server program to the client device, and a local proxy means which, when the client program issues a request to the server program, judges whether the request can be processed by the distributed server program, and sends the request to the server program which is executed on the server device, in the case that the local proxy means judges that the request can not be processed.

A second communication system according to the present invention includes a client device, a server device, an application directory server, and a proxy server, which are connected each other via a network. The server device carries out a server program which communicates with a client program which the client device carries out, and the application directory server is arranged to distribute the server program to the client device, and the proxy server includes a server program distribution instructing means for instructing the application directory server to distribute the server program to the client device, and the client device includes a server program distribution means which acquires the server program from the application directory server via the proxy server and distributes the acquired server program to the client device, and a local proxy means which, when the client program issues a request to the server program, judges whether the request can be processed by the distributed server program, and sends the request to the server program which is executed on the server device, in the case that the local proxy means judges that the request can not be processed.

A control method of a communication system according to the present invention for controlling the communication system in which a client device and a server device are connected each other via a network, and in which the client device includes a client program for communicating with a server program carried out by the server device, includes a server program distribution step for acquiring the server program from the server device and distributing the acquired server program to the client device, and a step in which, when the client program issues a request to the server program, it is judged whether the request can be processed by the distributed server program, and the request is sent to the server program which is executed on the server device, in the case that it is judged that the request can not be processed.

### The effect of the Invention

According to the present invention, it is possible to provide an art which enables to carry out a web application accompanied with a complicated data process, even in an environment in which that any communication means cannot be used at all.

### BRIEF DESCRIPTION OF THE DRAWING

FIG. 1 is a block diagram showing a configuration of a communication system according to a first exemplary embodiment of the present invention.

FIG. 2 is a flowchart showing an operation of the communication system according to the first exemplary embodiment of the present invention.

FIG. 3 is a block diagram showing a configuration of a communication system according to a second exemplary embodiment of the present invention.

FIG. 4 is a flowchart showing an operation of the communication system according to the second exemplary embodiment of the present invention.

FIG. 5 is a table showing contents of profile data according to the second exemplary embodiment of the present invention.

FIG. 6 is a block diagram showing a configuration of a communication system according to a third exemplary embodiment of the present invention.

FIG. 7 is a flowchart showing an operation of the communication system according to the third exemplary embodiment of the present invention.

### EXEMPLARY EMBODIMENT FOR CARRYING OUT THE INVENTING

The best mode for carrying out the present invention will be described in detail in the following.

### A First Exemplary Embodiment

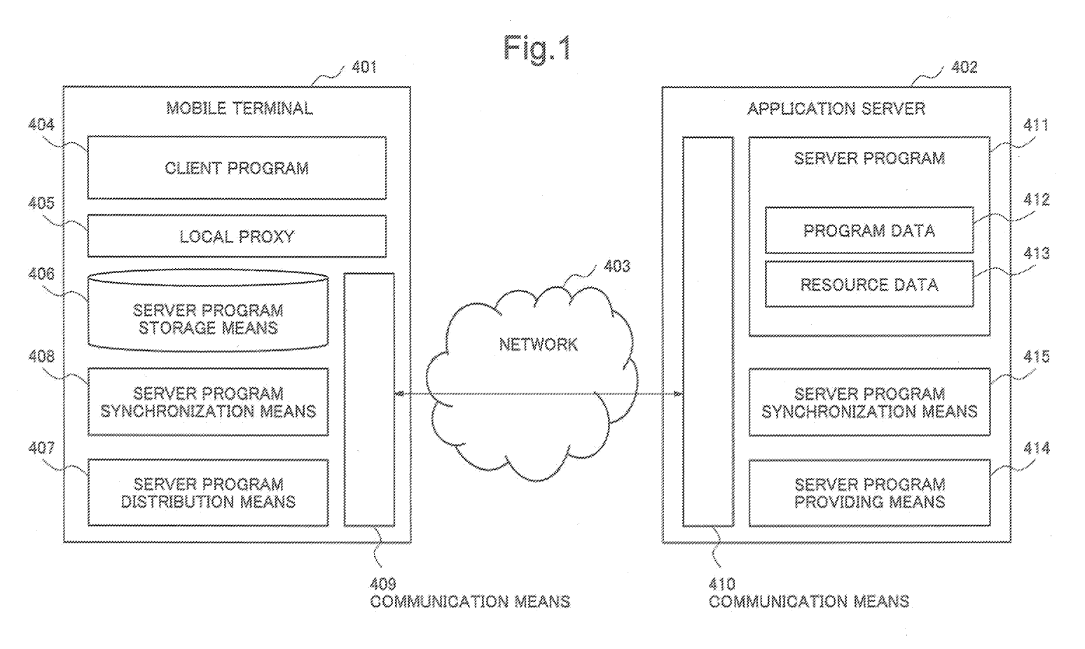

First, a configuration according to a first exemplary embodiment of the present invention will be described. FIG. 1 is a block diagram showing a system configuration according to the exemplary embodiment.

A mobile terminal 401 shown in FIG. 1 is, for example, a cellular phone and PDA (Personal Data Assistance). The mobile terminal 401 includes a display device which includes an organic EL and a liquid crystal display panel, and an input device such as a keyboard and a touch panel.

An application server 402 provides a network application.

A network 403 is the internet, LAN (Local Area Network) in an office or the like. The mobile terminal 401 and the application server 402 communicate each other via the network.

Moreover, the mobile terminal 401 includes a client program 404, a local proxy 405, a server program storage means 406, a server program synchronization means 408, a server program distribution means 407, and a communication means 409.

The client program 404 is a client program of a web application, and carries out a process through communicating with a server program. The client program 404 is, for example, a web browser program. The client program 404 carries out a process to change indication in reply to user's input and to acquire data through communicating with the server program, according to an instruction code which is described in HTML (HyperText Markup Language) and JavaScript (registered trademark), Flash (registered trademark) or the like.

The local proxy 405, which is HTTP (HyperText Transfer Protocol) proxy, carries out mediation of a communication which the client program 404 carries out, and transfers the mediated communication to an appropriate place. When the client program 404 tries to send a HTTP request to the server program, the local proxy 405 receives the request first. The local proxy 405 judges whether the received request can be processed by the server program which is stored in the server program storage means 406. In the case that the local proxy 405 judges that the request can be processed, the local proxy 405 activates the server program which is stored in the server program storage means 406, and makes the activated server program process the request, and then, ends the process. In the case that the local proxy 405 judges that the request cannot be processed, the local proxy 405 sends the received request to a server program 411 to make the server program 411 process the request.

A method, in which the local proxy 405 judges whether the HTTP request can be processed, will be described in the following. As a first method, in the case that the HPPT request, which is issued to the server program stored in the server program storage means 406, includes a list of application which can be processed, the local proxy 405 judges whether the server program exists in the list. As a second method, in the case that the local proxy 405 always requests the server program to process the request and, when the server program makes a response that the server program cannot carry out the process the local proxy 405 judges that the request cannot be processed.

The server program distribution means 407 acquires and installs the server program which is carried out in the mobile terminal 401. The server program distribution means 407 communicates with a server program providing means 414 by use of the communication means 409 and receives the server program which application server 402 holds. The server program distribution means 407 stores the received server program in the server program storage means 406.

The server program storage means 406 stores the server program which is acquired by the server program distribution means 407.

The server program synchronization means 408 makes the server program, which is stored in the server program storage means 406, synchronized with the server program which exists in the application server side. The server program synchronization means 408 communicates with a server program synchronization means 415 by use of the communication means 409 and sends a change, which is added to the server program stored in the server program storage means 406, to the server program 411. Moreover, the server program synchronization means 408 receives a change added to the server program 411 from the server program synchronization means 415 and makes the server program, which is stored in the server program storage means 406, updated.

The communication means 409 communicates with the application server 402 via the network 403. At this time, wireless LAN, a cellular phone network, PHS (Personal Handy-phone Systems), IrDA (Infrared Data Association), Bluetooth (registered trademark), WiMAX (registered trademark) or the like is exemplified as a physical means of communication.

Furthermore, the application server 402 includes the server program 411, the server program synchronization means 415, the server program providing means 414 and a communication means 410.

The server program 411, which is a server program of web application, processes a request from the client program 404. Moreover, the server program 411 is divided into program data 412 which is execution procedure, and resource data 413 to which the program data 412 refers at a time of execution. The program data 412 is, for example, a binary file based on the C language and Java (registered trademark), or a script file described in Ruby and Perl. The resource data 413 is, for example, information stored in an image file and a database.

The server program providing means 414 sends the server program 411 to the mobile terminal 401. The server program 411 includes the program data 412 and the resource data 413 as mentioned above. The resource data 413 is generally very large amount of data in comparison with the program data 412. Therefore, the resource data 413 cannot be stored in the server program storage means 406, whose capacity is limited, as it is. The server program providing means 414 sends a whole of program data 412 and a predetermined subset of resource data 413 to the server program distribution means 407 and consequently, the subset of the server program 411 is distributed to the mobile terminal 401.

The server program synchronization means 415 makes the server program 411 synchronized with the server program which is stored in the server program storage means 406. The server program synchronization means 415 receives the change added to the server program, which is stored in the server program storage means 406, from the server program synchronization means 408 and makes the server program 411 updated. Moreover, the server program synchronization means 415 sends a change, which is added to the server program 411, to the server program synchronization means 408 by use of the communication means 410.

The communication means 410, which is corresponding to the communication means 409, communicates with the mobile terminal 401 via the network 403.

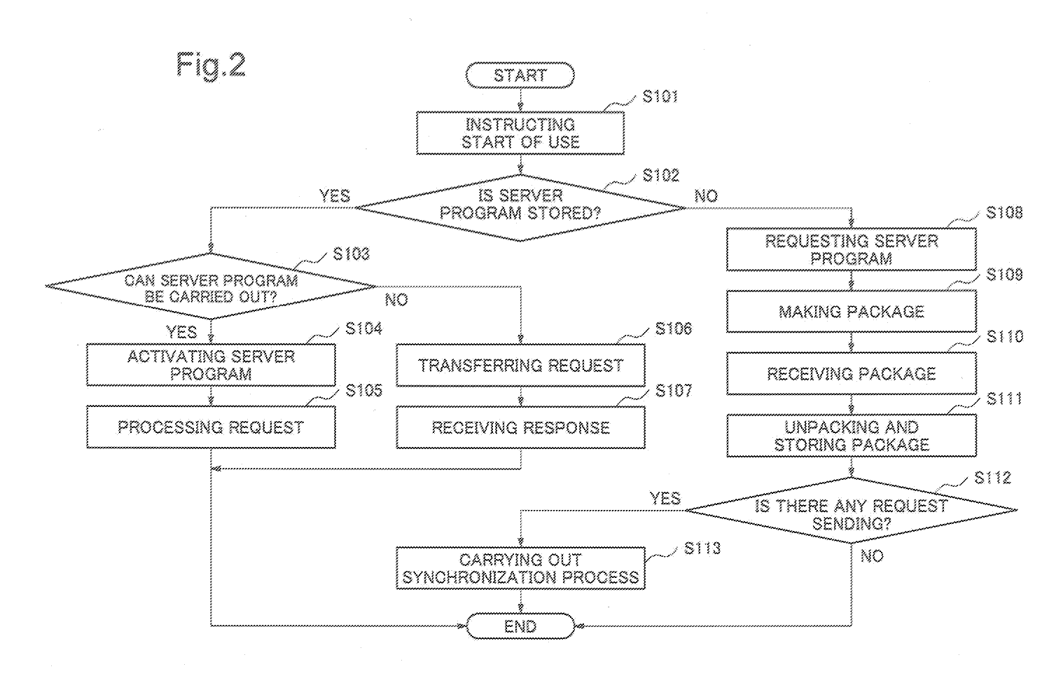

Next, an operation of each device according to the exemplary embodiment will be described. FIG. 2 is a flowchart showing a procedure of process of each device according to the exemplary embodiment.

According to FIG. 2, user instructs firstly the client program 404 to use a Web application through using an inputting means, etc. Then, the client program 404 accepts the instruction. The client program 404 specifies the application server 402 which provides the designated web application, and sends the HTTP request, whose destination is the application server 402, to the local proxy 405 (Step S101).

The local proxy 405 judges whether the server program 411 has been stored already in the server program storage means 406, through checking the application server 402 which is the destination of the received HTTP request (Step S102).

In the case that the server program 411 has been stored already in the server program storage means 406, a process for installing the stored server program 411 is complete. The local proxy 405 judges whether the stored server program 411 is operable (Step S103).

In the case that the server program 411 is in an operable state, the local proxy 405 activates the program, and delivers the HTTP request, which was received previously, to the activated program so as to make the activated program carry out to process the request (Step S104). The local proxy 405 receives a HTTP response as a result of the process, and transfers the HTTP response to the client program 404 as it is, and ends the process (Step S105).

In the case that the server program 411 is not in the operable state because of being in a process for installation or the like, the local proxy 405 connects to the application server 402 by use of the communication means 409 and transfers the HTTP request, which was received to previously, to the server program 411 (Step S106). The local proxy 405 receives a result of the process, which the server program 411 carries out, as a HTTP response, and transfers the received HTTP response to the client program 404 as it is, and ends the request process (Step S107). At this time, the local proxy 405 records simultaneously that the request has been processed by the application server 402 during the installation process.

In the case that the server program 411 is not stored in the server program storage means 406, the local proxy 405 instructs the server program distribution means 407 to acquire the server program 411 (Step S108). The server program distribution means 407 connects to the application server 402 by use of the communication means 409 according to the instruction to acquire the server program 411, and requests the server program providing means 414 to provide the server program 411. The connection, which is different from the connection in Step S107, can use any protocol, which is capable of transferring in a file unit, such as not only HTTP but also FTP (File Transfer Protocol) and RCP (Remoto CoPy). Moreover, the local proxy 405 connects to the application server 402 by use of the communication means 409 and sends the HTTP request, which was received previously, to the server program 411 and receives a HTTP response as a result of processing the HTTP request, in parallel to instructing the server program distribution means 407.

Further, the case, in which the server program 411 is acquired immediately if the server program 411 is not stored in the server program storage means 406, has been described here. However, an event, which triggers acquisition of the server program 411, is not limited to the case. A case, in which the server program is acquired when a number of issuing the request to the server 402 reaches to or over a predetermined number, or the server program is acquired when rate of issuing the request to the server 402 reaches to or over a predetermined number is also applicable. Moreover, a case, in which the server program 411 is acquired not only at timing when the request is issued but also at timing when traffic congestion becomes not higher than a predetermined level, or when a process load of the mobile terminal 401 becomes not higher than a predetermined level is also useful.

The server program providing means 414 packages a whole of the program data 412 and a predetermined part of the resource data 413, and sends the package to the server program distribution means 407 in reply to the request from the server program distribution means 407 (Step S109).

The server program distribution means 407 receives the package from the server program providing means 414 (Step S110). Since it takes much time to receive a large amount of data such as the server program, communication in this process may be disconnected halfway in some cases. The server program distribution means 407 prepares for an unexpected communication disconnection. That is, the server program distribution means 407 has a function to resume acquiring the server program 411 when communication is restored, even if communication is disconnected.

The server program distribution means 407 unpacks the package, which has been received completely, and stores the package in the server program storage means 406 (Step S111). Moreover, the server program distribution means 407 notifies the local proxy 405 that the request to the server 402 should be processed by use of this package. Moreover, the server program distribution means 407 judges whether there is a record on the request which has been processed by the application server 402 during installation of the server program 411 (Step S112).

In the case that any request is not processed by the application server 402 during installation of the server program 411, the server program distribution means 407 judges that installation of the server program 411 has been completed.

In the case that some request has been processed by the application server 402 during installation of the server program 411, a state of the installed server program 411 becomes different from one of the server program 411 which works on the application server 402. Therefore, the server program distribution means 407 instructs the server program synchronization means 408 to carry out the synchronization process (Step S113). The server program synchronization means 408 connects to the application server 402 by use of the communication means 409, and acquires update information from the server program synchronization means 415. The server program synchronization means 408 updates the server program 411, which is stored in the server program storage means 406, with the acquired update information. By carrying out the synchronization process, the state of the program installed in the mobile terminal 401 and the state of the program executed in the server 402 are parallel each other, and consequently, it is possible to provide user with an equivalent service whichever of the mobile terminal 401 and the server 402 processes the request. When the synchronization process is completed, the server program distribution means 407 judges that installation of the server program 411 has been completed.

According to the exemplary embodiment described above, it is possible that the mobile terminal 401 installs the server program 411 without making user be conscious of the installation. During installation of the server program 411, the mobile terminal 401 connects to the application server 402 and uses a web application as usual. Since, after completion of installing the server program 411, the mobile terminal 401 uses a web application by use of the server program 411 which is stored in the server program storage means 406, there is no case that the web application can not be used because of the process for installing the server program 411. Moreover, since, after installation of the server program 411, the mobile terminal 401 carries out the synchronization process automatically if necessary, user does not need to be conscious that a place, at which the server program 411 is executed, switches over from the application server 402 to the mobile terminal 401.

Further, while the case, in which the request to the server 402 is processed entirely by the downloaded program, has been described according to the above-mentioned example, it may be preferable that only a specific request is processed by the downloaded program. In this case, it is enough that the server 402 prepares a table which indicates association between a request and a place at which the request should be processed, and sends the table which is embedded in the package. After unpacking the package, the server program distribution means 407 notifies the local proxy 405 of table contents in Step S111.

Meanwhile, there is a case that user's confirmation is mandatory from a view of security of the mobile terminal 401 when the server program 411 is installed. According to a security policy of the mobile terminal 401, not all web applications are installed automatically. In some cases, the local proxy 405 may indicate a dialogue to prompt user to confirm the installation in the above-mentioned step (Step S106). It may be preferable to adopt a method that user sets beforehand a list of the application server 402 which permits the automatic installation, and the local proxy 405 judges whether installation of the server program 911, which is sent from the application server 402, is permitted in the Step (Step S106).

### A Second Exemplary Embodiment

It is general that one web application has a plurality of functions like the scheduler web application, for example, has a function of “referring to schedule of a specific day” and a function of “writing in schedule”. In the case that the server program is packed as one package according to the above-mentioned exemplary embodiment, inconvenience that it is impossible to use any function until installation of the package is completed is caused.

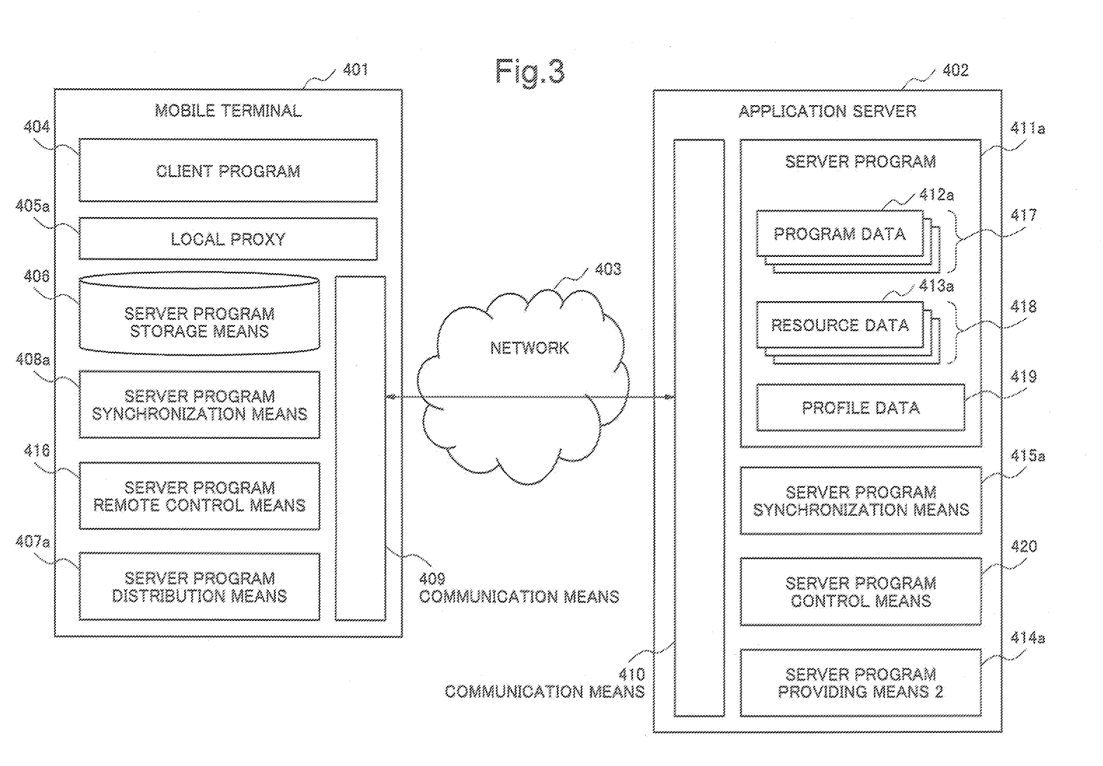

Hereinafter, a case that the server program is packaged in a function unit, and the installation process is carried out in the respective function unit will be described. First, a according to the exemplary embodiment will be described. FIG. 3 is a block diagram showing a configuration of a system according to the exemplary embodiment. A function block which carries out the same operation as a function block described FIG. 1 has the same code as the function block described FIG. 1 has. Repetition of the same description is avoided as far as the description is not necessary.

In the system according to the exemplary embodiment, the mobile terminal 401 and the application server 402 communicate each other via the network 403.

The mobile terminal 401 includes the client program 404, a local proxy 405a, the server program storage means 406, a server program synchronization means 408a, a server program distribution means 407a, a server program remote control means 416 and the communication means 409.

The local proxy 405a, which is a communication proxy, carries out mediation of HTTP communication which the client program 404 carries out, and transfers the HTTP communication town appropriate place. According to an arranged criterion for judgment, the local proxy 405a judges whether a request, which is received from the client program 404, can be processed by the server program which is stored in the server program storage means 406. The criterion for judging whether the request can be processed is set by the server program distribution means 407a. In the case that the local proxy 405a judges that the request can be processed by the server program stored in the server program storage means 406, the local proxy 405a activates the server program stored in the server program storage means 406, and makes the activated server program process the request. On the other hand, in the case that the local proxy 405a judges that the request can not be processed, the local proxy 405a sends the request to a server program 411a to make the server program 411a process the request.

The server program distribution means 407a acquires program data 412a and resource data 413a, which compose the server program, in a function unit, and store these data in the server program storage means 406. Moreover, the server program distribution means 407a sets a criterion in the local proxy 405a for judging which function is available on the basis of installed data with reference to dependence between a group of plural program data 417 and a group of plural resource data 418 which are described in profile data 419.

A server program synchronization means 408a synchronizes the server program, which is stored in the server program storage means 406, with the server program 411a in a function unit.

The server program remote control means 416 communicates with a server program control means 420, and uses a function of the server program which is not stored in the server program storage means 406. When one function of the server program, which is stored in the server program storage means 406, uses program data and resource data which are not stored in the server program storage means 406, the server program remote control means 416 instructs the server program control means 420 to carry out the program data 412a remotely. As the remote control function of the server program remote control means 416, a function to access a large amount of data like a process to issue a query to a database, and a function which should not be carried out by a mobile terminal from a view of security like a function to encrypt data by use of the secret key are exemplified.

Further, the application server 402 includes the server program 411a, a server program synchronization means 415a, a server program providing means 414a, the profile data 419, the server program control means 420 and the communication means 410.

The server program 411a, which is a server program of web application, is a program to process a request from the client program 404. Moreover, the server program 411a is divided into a set of the program data 412a which is execution procedure of each function, and a set of the resource data 413a to which the program data 412a refer.

Moreover, the server program 411a includes also the profile data 419 that describes which the resource data 413a the program data 412a uses.

The server program providing means 414a provides the program data 412a and the resource data 413a to the server program distribution means 407a in a function unit.

The server program synchronization means 415a synchronizes the server program 411a with the server program, which is stored in the server program storage means 406, in a function unit.

The server program control means 420 instructs the server program 411a to carry out a process according to a request from the server program remote control means 416. The server program 411a can execute a program and sends resources in a function unit. Therefore, the server program control means 420 instructs to carry out a process such as executing of the program and sending of the resources in a function unit, in addition to instructing to carry out all functions of the server program 411a.

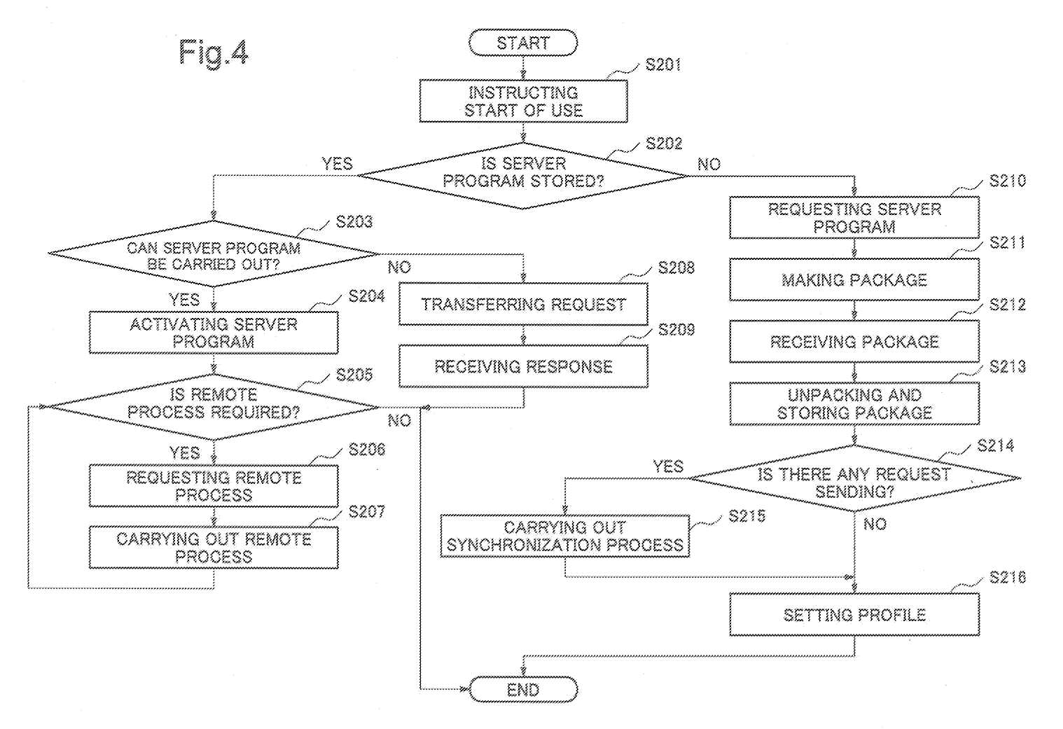

Next, an operation of each device according to the exemplary embodiment will be described. FIG. 4 is a flowchart showing a procedure of process of each device according to the exemplary embodiment.

Firstly, user instructs the client program 404 to use a Web application through using an inputting means, etc. Then, the client program 404 accepts the instruction. The client program 404 specifies the application server 402 which provides the designated web application, and a function of the Web application which should be used, and sends a HTTP request, which designates the function to be used to the application server 402, to the local proxy 405 (Step S201).

The local proxy 405a judges whether the specified function of the server program 411a is stored in the server program storage means 406, on the basis of the destination information and the function to be used which are included in the received HTTP request (Step S202). A method that the local proxy 405a specifies the Web application and its function is different per application. There is a method to specify the Web application, which is used with a host name which is included in URL (Uniform Resource Locator) indicated in the HTTP request, and to specify the function with a directory name, a file name and a calling parameter, etc.

In the case that a function, which the client program 404 requests, is stored in the server program storage means 406, the local proxy 405a judges whether the function is available (Step S203). The local proxy 405a carries out the judgment with reference to the program and the resources, which are stored in the server program storage means 406, on the basis of the criterion for judgment which is set by the server program distribution means 407a.

In the case that the function, which the client program 404 requests, is available, the local proxy 405a activates a program corresponding to the function, and delivers the HTTP request, which was received previously, to the activated program, and makes the activated program process the HTTP request (Step S204). The local proxy 405a receives a result of the process which is carried out by the activated program, and delivers the result to the client program 404, and then, ends the process.

Here, in the case that program data and resource data, which are not stored in the server program storage means 406, become necessary during processing the program as mentioned above (Step S205), the local proxy 405a instructs the server program remote control means 416 to carry out the remote control.

The server program remote control means 416 connects to the application server 402 by use of the communication means 409, and instructs the server program control means 420 to carry out a specific program and to send specific resources, according to the instruction from the local proxy 405a (Step S206).

The server program control means 420 carries out the specific program of the server program 411a, and acquires the specific resource according to the instruction from the server program remote control means 416, and then, sends a result to the server program remote control means 416 (Step S207). The server program remote control means 416 receives the result from the server program control means 420, and delivers the result to the program which is in a processing state, and makes the program resume control. The program, which resumes the control, continues the process, and delivers a result of the process to the local proxy 405a as a response. The local proxy 405a deliver the received response to the client program 404 as it is, and end the process.

In the case that the function, which the client program 404 requests, is stored in the server program storage means 406, but the function is not available because of being in the installation process or the synchronization process, the local proxy 405a connects to the application server 402 by use of the communication means 409, and transfers the HTTP request, which was received previously, to the server program 411a (Step S208). The local proxy 405a receives a result of process, which the server program 411a carries out, as a HTTP response (Step S209), and transfers the result to the client program 404 as it is and ends the request process. At this time, the local proxy 405a records that the function, which the client program 404 requests, has been processed by the application server 402.

In the case that the function, which the client program 404 requests, is not stored in the server program storage means 406, the local proxy 405a instructs the server program distribution means 407a to acquire the program data 412a and the resource data 413a which are the corresponding functions of the server program 411a (Step S210). The server program distribution means 407a communicates with the server program providing means 414a to request the program data 412a (Step S211).

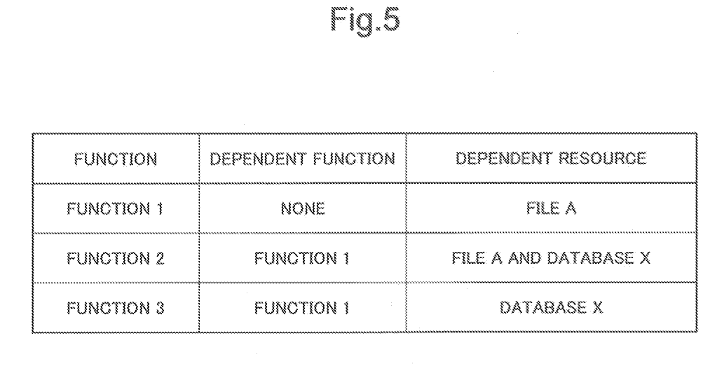

The server program providing means 414a packages the program data 412a, the resource data 413a which the program data 412a requires, and the profile data 419 with reference to the profile data 419, and sends the packaged data to the server program distribution means 407a (Step S211) (Step S212). FIG. 5 shows an example of information described in the profile data 419. According to the example, the server program includes functions 1 to 3, a file A and a database X. In the case That the server program distribution means 407a requests the server program providing means 414a to send the function 1, the server program providing means 414a packages the function 1, the file A and the profile data since the function 1 uses the file A, and sends it to the server program distribution means 407a.

The server program distribution means 407a unpacks the received package, and stores the unpacked data in the server program storage means 406 (Step S213). At this time, the server program distribution means 407a judges whether there is a record that any request has been processed by the application server 402 during installation of the function.

In the case that any request is not processed by the application server 402 during installation of the function, the server program distribution means 407a interprets description of the profile data 419 and updates the local proxy 405a (Step S216). Referring to the example of FIG. 5 again, the local proxy 405a sets that the request of the function 1, which the client program 404 issues, may be processed by a program which is stored in the server program storage means 406, in the case that the function 1 and the file A exist in the server program storage means 406. When the setting has been completed, the server program distribution means 407a judges that installation of the server program 411a has been completed.

In the case that some request is processed by the application server 402 during installation of the function, the server program distribution means 407a instructs the server program synchronization means 408a to carry out the synchronization process (Step S215). When the synchronization process has been completed, the server program distribution means 407a updates the local proxy 405a with description of the profile data 419 (Step S216) and then, ends the installation process.

By dividing the server program in a function unit like the exemplary embodiment, the following two effects are obtained. First, it is possible to make a time, which is required for installation, short since package size per function becomes small. Second, it is possible to separate a function which uses a huge DB, and a function which uses information not desired to be out from the server from a view of security. As a result, it is possible to cover more applications than ones in the case that a whole of server program is packaged.

### A Third Exemplary Embodiment

While communication is carried out only between the mobile terminal and the application server according to the exemplart embodiment mentioned above, a configuration for obtaining the effect of the present invention is not limited to such the simple configuration.

Hereinafter, a case, in which the server program is carried out not by the application server but by an external directory server, and distribution of the server program to the mobile terminal is carried out by an external proxy server, will be described.

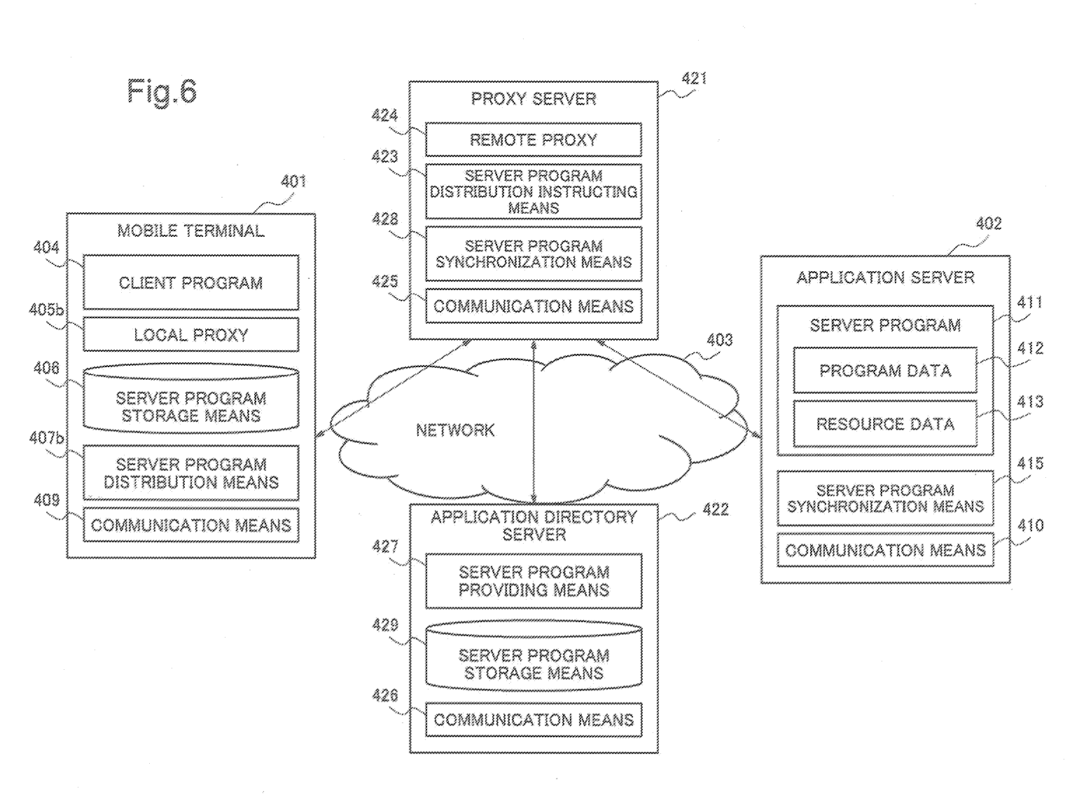

First, a configuration of a system according to the exemplary embodiment will be described. FIG. 6 is a block diagram showing the configuration of the system according to the exemplary embodiment. The same function module as a function module shown in FIG. 1 and FIG. 3 has the same code as the function module shown in FIG. 1 and FIG. 3 has.

According to the system of the exemplary embodiment, a proxy server 421 and an application directory server 422 in addition to the mobile terminal 401 and the application server 402 are connected to the network 403 and communicate each other.

The mobile terminal 401 includes the client program 404, a local proxy 405b, the server program storage means 406, a server program distribution means 407b and the communication means 409.

In response to a HTTP request from the client program 404, the local proxy 405b, which is a HTTP proxy, judges whether a server program is stored in the server program storage means 406. In the case that the server program is stored, the local proxy 405b activates the server program and makes it process the request. On the other hand, in the case that the server program is not stored, the local proxy 405b transfers the request to the proxy server 421.

The server program distribution means 407b stores the server program in the server program storage means 406 according to an instruction issued by a server program distribution instructing means 423.

The application server 402 includes the server program 411, the server program synchronization means 415 and the communication means 410.

The proxy server 421 includes a remote proxy 424, the server program distribution instructing means 423, a server program synchronization means 428 and a communication means 425.

The remote proxy 424 is a HTTP proxy that distinguishes a web application, which is a connection destination, on the basis of a HTTP request sent from the local proxy 405b, judges whether the server program is distributed to the mobile terminal 401, and, transfers the HTTP request to the application server 402. The judgment whether the server program is distributed to the mobile terminal 401 is carried out by the remote proxy 424 inquiring whether the application directory server 422 holds the server program related to the corresponding web application. In the case that the server program related to the corresponding web application is found, the remote proxy 424 instructs the server program distribution instructing means 423 to distribute the server program to the mobile terminal 401.

The server program distribution instructing means 423 sends the server program, which is acquired from an application directory server 422T, to the server program distribution means 407b and instructs the server program storage means 406 to store the server program. Moreover, in the case that the program data and the resource data are changed, the server program distribution instructing means 423 sends the updated data to the server program distribution means 407b, and consequently, keeps the data, which is stored in the server program storage means 406, newest.

The communication means 425 is a communication means used like the communication means 409 and the communication means 410 when the proxy server 421 communicates with other server and other terminal.

The application directory server 422 includes a server program providing means 427, a server program storage means 429 and a communication means 426.

The server program providing means 427 judges whether a server program such as the server program 411, which works on the application server 402, is stored in the server program storage means 429, and provides the server program to the proxy server 421.

The server program storage means 429 stores a server program such as the server program 411. The server program stored in the server program storage means 429 is registered in the application server 402 beforehand.

The communication means 426 is a communication means used like the communication means 409 and the communication means 410 when the proxy server 421 communicates with other server and other terminal.

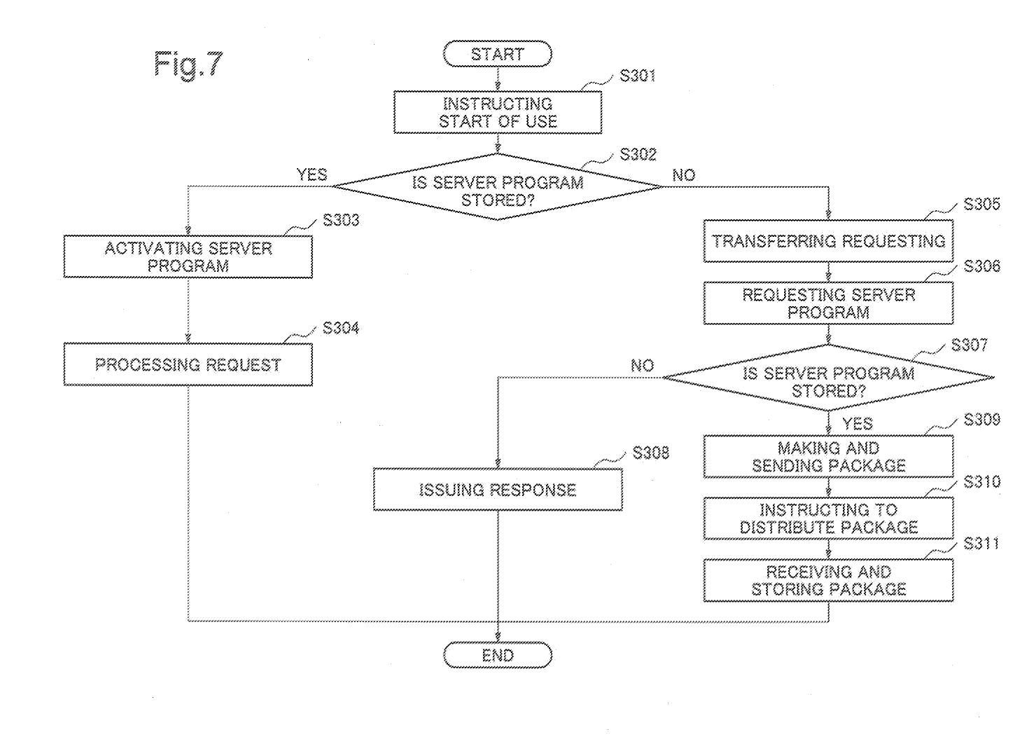

Next, while an operation of each device according to the exemplary embodiment will be described, detailed description on an operation, which overlaps with the operation according to the previously mentioned exemplary embodiment, is omitted. FIG. 7 is a flowchart showing a procedure of process of each device according to the exemplary embodiment.

<Installation Process>

A flow, in which a server program is installed automatically in response to a request issued from the client program 404, will be described in the following.

The local proxy 405b receives a HTTP request from the client program 404, and judges whether a corresponding server program is stored in the server program storage means 406 (Step S301) (Step S302). In the case that the corresponding server program is stored, the local proxy 405b activates the corresponding program and makes the corresponding program process the request, and returns a response to the client program 404 (Step S303) (Step S304).

In the case that the corresponding server program is not stored, the local proxy 405b connects to the proxy server 421 by use of the communication means 409, and sends the HTTP request to the remote proxy 424 (Step S305).

The remote proxy 424 acquires a web application, which is a connection destination, on the basis of a header of the received HTTP request, and inquires of the server program providing means 427 whether the server program can be acquired, after connecting to the application directory server 422 by use of the communication means 425 (Step S306). The remote proxy 424 sends the HTTP request, which is received in parallel, to the application server 402 and carries out a usual process as the HTTP proxy.

The server program providing means 427 judges whether the corresponding server program is stored in the server program storage means 429 (Step S307), and in the case that the corresponding server program is not stored, the server program providing means 427 returns a response that the server program can not be acquired to the remote proxy 424 (Step S308). In the case that the server program cannot be acquired, the remote proxy 424 does nothing.

In the case that the corresponding server program is stored in the server program storage means 429, the server program providing means 427 packages the corresponding server program and sends the package to the remote proxy 424 (Step S309).

In the case that the remote proxy 424 receives the package of server program, the remote proxy 424 instructs the server program distribution instructing means 423 to distribute the package to the mobile terminal 401 (Step S310). The server program distribution instructing means 423 connects to the mobile terminal 401 and sends a request, which requests to distribute the server program to the mobile terminal 401, together with the package to the server program distribution means 407b.

The server program distribution means 407b unpacks the package and stores the package in the server program storage means 406 (Step S311).

<Synchronization Process>

A flow in which, when data which the application server 402 holds is changed, the change of data is informed to the mobile terminal 401 will be described in the following.

The program data 412 and the resource data 413, which compose the server program 411, are changed by a request from another user and update of the program, etc.

The server program synchronization means 415 monitors the server program 411. When the server program synchronization means 415 detects a change of the program data 412 and the resource data 413, the server program synchronization means 415 connects to the proxy server 421 by use of the communication means 410, and sends notification which indicates that the change of data occurs, and a difference in data to the server program synchronization means 428.

The server program synchronization means 428 makes an update package of the server program on the basis of the difference in data.

The server program synchronization means 428 instructs to distribute the update package to the mobile terminal 401. The server program distribution instructing means 423 connects to the mobile terminal 401, and sends a request, which requests to update the server program, together with the update package to the server program distribution means 407b.

The server program distribution means 407b unpacks the update package and updates an old server program which is stored in the server program storage means 406.

According to the configuration of the exemplary embodiment, a communication process, which is required to distribute the server program, is limited at most to the process that the mobile terminal 401 connects to the proxy server 421 and sends the HTTP request (Step S305). According to the exemplary embodiment, the proxy server 421 can carry out the communication process, which is required to distribute the server program, by proxy. Consequently, it is possible to make the configuration of the client device simplified.

While each exemplary embodiment of the present invention has been described above, the present invention is not limited to each exemplary embodiment described above. Various modifications are possible within the scope of the present invention. It is possible to carry out the above-mentioned control operation in the exemplary embodiment by use of hardware, software or a combined configuration of the software and the hardware.

In the case of carrying out the operation by software, it is possible that a program, which records sequence of the processes, is installed in a memory of a computer mounted on dedicated hardware and then, is executed. It is also possible that the program is installed and executed in a general-purpose computer which can carry out various processes.

For example, it is possible that the program is recorded in advance in a hard disc and ROM (Read Only Memory) as a storage medium. It is also possible that the program is stored (recorded) temporarily or permanently in a removable storage medium. The removable storage medium can be provided as so-called package software. Further, a floppy (registered trade mark) disc, CD-ROM (Compact Disc Read Only Memory), a MO (Magneto optical) disc, DVD (Digital Versatile Disc), a magnetic disc, a semiconductor memory or the like is exemplified as the removable storage medium.

Further, the program is installed in the computer from the removable storage medium mentioned above. Or, the program is downloaded by radio to the computer from a download site. Or, the program is transferred to the computer by a wire via a network.

Further, this application is based upon and claims the benefit of priority from Japanese Patent Application No. 2008-127578, filed on May 14, 2008, the disclosure of which is incorporated herein in their entirety by reference.

### Description of Code

401 Mobile terminal
402 Application server

### 403 Network

404 Client program
405 Local proxy
406 Server program storage means
407 Server program distribution means
408 Server program synchronization means
409 and 410 Communication means
411 Server program
412 Program data
413 Resource data
414 Server program providing means
415 Server program synchronization means
421 Proxy server
422 Application directory server

1. A client device which is connected via a network to a server computer carrying out a server program, characterized by comprising:
a client program which communicates with said server program;
a server program distribution unit which acquires said server program from said server computer and distributes said acquired server program to said client device; and
a local proxy unit which, when said client program issues a request to a server program, judges whether said request can be processed by said distributed server program, and sends said request to said server program which works on said server computer, in the case that said local proxy unit judges that said request can not be processed.

2. The client device according to claim 1, characterized by further comprising:
a server program synchronization unit which synchronizes both of distributed server program and said server program which is executed on said server computer.

3. The client device according to claim 1, characterized in that:
said server program is divided into program data and resource data; and
said server program distribution unit acquires a whole of said program data and a part of said resource data when said server program distribution unit acquires said server program.

4. The client device according to claim 3, characterized in that:
said program data and said resource data are divided in a function unit; and
said server program distribution unit acquires said program data and said resource data in said function unit when said server program distribution unit acquires said server program.

5-6. (canceled)

7. A server device which is connected via a network to a client device carrying out a client program, characterized in that:
said server device includes:
a server program which communicates with said client program;
a server program providing unit which sends a subset of said server program to said client device; and
server program synchronization unit which sends a change added to said server program to said client device; and
said server program carries out a process, in the case that said client program issues a request to said server program and said request is sent to said server program.

8. (canceled)

9. A communication system in which a client device and a server device are connected each other via a network, characterized in that:
said client device includes:
a client program for communicating with a server program which said server device carries out;
a server program distribution unit which acquires said server program from said server device and distributes said acquired server program to said client device; and
a local proxy unit which, when said client program issues a request to a server program, judges whether said request can be processed by said distributed server program, and sends said request to said server program which is executed on said server device, in the case that said local proxy unit judges that said request can not be processed.

10-11. (canceled)
